(19) United States
(12) Patent Application Publication
(10) Pub. No.: US 2008/0232707 A1
(43) Pub. Date: Sep. 25, 2008

(54) Motion blurred image restoring method

(75) Inventors: Wen-Hao Lee, Jhonghe City (TW); Shang-Hong Lai, Hsinchu (TW); Chia-Lun Chen, Hsinchu (TW); Shih-Chieh Chen, Hsinchu (TW)

Correspondence Address: RABIN & Berdo, PC, 1101 14TH STREET, NW, SUITE 500, WASHINGTON, DC, 20005, US

(73) Assignees: INDUSTRIAL TECHNOLOGY RESEARCH INSTITUTE, Hsinchu (TW); NATIONAL TSING HUA UNIVERSITY, Hsinchu (TW)

(21) Appl. No.: 11/826,479

(22) Filed: Jul. 16, 2007

(30) Foreign Application Priority Data
Mar. 23, 2007 (TW) 096110195

(51) Int. Cl. G06K 9/40

(52) U.S. Cl. 382/255

(57) ABSTRACT

A motion blurred image restoring method includes following steps. A blur parameter is estimated through a global motion relation between a target image and an image next to the target image, and a restored image is generated through the blur parameter. In order to avoid errors from occurring to the estimated blur parameter, the blue parameter is further adjusted according to the image quality value of the restored image, such that the restored image has a more desirable image quality.

### CROSS-REFERENCE TO RELATED APPLICATIONS

This non-provisional application claims priority under 35 U.S.C. § 119(a) on Patent Application No(s). 096110195 filed in Taiwan, R.O.C. on Mar. 23, 2007, the entire contents of which are hereby incorporated by reference.

### BACKGROUND OF THE INVENTION

1. Field of the Invention

The present invention relates to a motion blurred image restoring method. More particularly, the present invention relates to a motion blurred image restoring method, which is capable of generating a restored image according to a global motion relation between a target image and a reference image neighboring to the target image, and adjusting a blur parameter according to the image quality value of the restored image, such that the restored image has a more desirable image quality.

2. Related Art

In the computer vision and image processing fields, image restoring has always been an important issue in all ages, which includes various applications, for example, the restoration of monitoring systems, medical images, outer space images, and even the restoration of blurred images shot in daily life, etc. The motion blurring often makes the quality of the shot image be negatively affected, and the reason for the motion blurring lies in that, a relative motion is generated between the shot object and the camera (the video camera) during the exposure period. Although the motion blurring may be used to emphasize the visual effect of the dynamic scene in certain applications, but in most situations, the motion blur affects the shooting effect and thus, the image quality is greatly deteriorated.

As for the conventional method of solving the above problems, various different techniques are proposed. In terms of the hardware, the technique includes anti-shake motion compensation, and shortening the exposure time by controlling through the hardware. In terms of the software, various solutions are proposed as for the blur parameter estimation, image restoration, and post processing. However, the methods may affect the image quality of the restored image due to the errors of the parameter estimation. For example, in U.S. Pat. No. 6,888,566, a method of estimating the blur parameter through the optimization of the error function is disclosed. In the U.S. Pat. No. 6,987,530, it mentions that the changing situation of the pixel values of the image on the vertical, the horizontal, and the two diagonal directions is observed to serve as the basis for estimating the blur parameter, and the strength of the high frequency signal of the image on the blurring direction is enhanced, thereby obtaining the restored image.

### SUMMARY OF THE INVENTION

Among the current methods of estimating the blur parameter, the error easily occurs during the blur parameter estimation process, so as to affect the image quality of the restored image. Therefore, the present invention is directed to a method of using the information of a reference image neighboring to a target image as the basis for estimating the blur parameter, and further calculating the image quality value through using a pre-trained image quality assessment module, thereby automatically adjusting the blur parameters, so as to obtain the best restored image and to solve the problem of the prior art that the error easily occurs during the blur parameter estimation process.

In order to achieve the above the objective, the method provided by the present invention includes: reading a target image and a reference image neighboring to the target image of the motion blurring; comparing the target image with the reference image to obtain a global motion relation of the target image, and generating at least one blur parameter through the obtained global motion relation; and restoring the target image with the blur parameter to generate a restored image.

In addition, the method provided by the present invention further includes: extracting at least one image feature of the restored image through at least one image feature extraction method; calculating an image quality value of the restored image through the extracted image feature; and adjusting the blur parameter, if the image quality value does not reach a preset threshold or is not stable.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, which thus is not limitative of the present invention, and wherein:

FIG. 1A is a flow chart of a motion blurred image restoring method according to the present invention;

FIG. 1B is a flow chart of a method of generating a blur parameter according to the present invention; and

FIG. 2 is a flow chart of a method of establishing a pre-trained image quality assessment module according to the present invention.

### DETAILED DESCRIPTION OF THE INVENTION

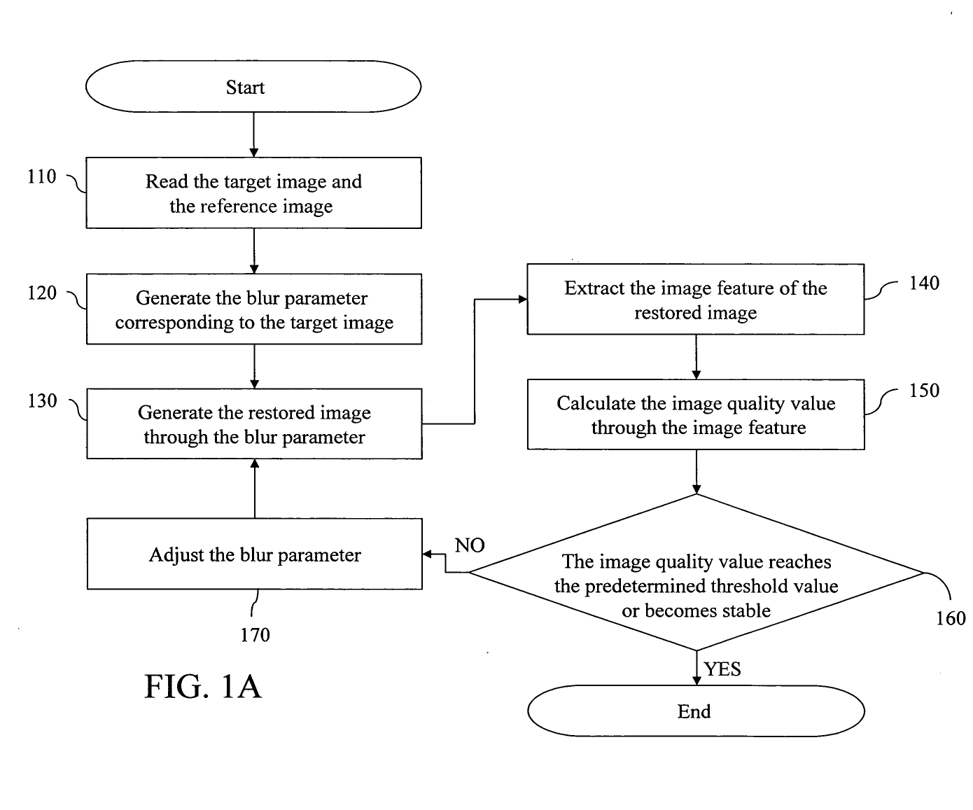

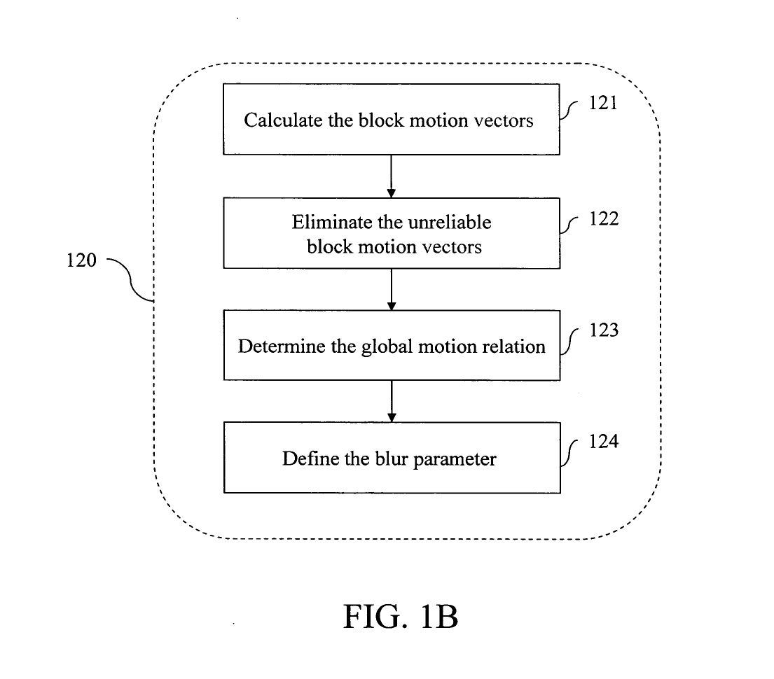

The system and method for operating the present invention are illustrated below through embodiments. Referring to FIG. 1A, it is a flow chart of an image restoring method according to the present invention.

In the present invention, after a film is input, target images are read from the film piece by piece, and a sequence relation exists among the target images. That is, when the present invention selects a target image for being modified, the selected target image at least has a previous image and a next image, which are neighboring to the selected target image. In this embodiment, the next image neighboring to the target image is taken as the reference image, and the present invention reads the target image and the reference image from the film (Step 110).

Next, the present invention compares the target image with the reference image to obtain a global motion relation of the target image, and generates a blur parameter corresponding to the target image through the global motion relation of the target image (Step 120). In this embodiment, the blur parameter of the target image includes a blur angle and a blur extent. In the present invention, after the blur parameter of the target image is generated, the target image is restored with the blur parameter to generate a restored image (Step 130).

The step of generating the blur parameter is further illustrated as follows (Step 120). Referring to FIG. 1B, when the present invention reads images piece by piece from the film (Step 110), the motion estimation technique is used to calculate block motion vectors of the target image through the image information of the reference image (Step 121).

In addition, when the block motion vectors of the target image are generated (Step 121), the image has motion vectors estimated by blocks with a homogeneous or one-dimension structure, so that the situation inconsistent with the image global motion easily occurs, so as to affect the global motion estimation. Therefore, the present invention further includes a step of eliminating unreliable block motion vectors (Step 122), in which an eigen-decomposition is performed on the structure tensor A corresponding to each block in the target image, so as to observe the magnitude of the eigenvalues, and thus determining and eliminating the parts having a homogeneous or one-dimension structure in the blurred image. The structure tensor is that

$$A = [ \begin{matrix}〈 {I}_{x}^{2} 〉 & 〈 {I}_{x} {I}_{y} 〉 \\ 〈 {I}_{x} {I}_{y} 〉 & 〈 {I}_{y}^{2} 〉\end{matrix} ] .$$

Next, in the present invention, the information such as the translation distance, the rotation angle, and the scaling of the object in the target image and the reference image is used to determine the global motion relation of the target image. In this embodiment, a robust estimation process, referred as RANSAC, is used to calculate the affine module and to obtain the translation distance, the rotation angle, and the scaling information, so as to determine the global motion relation (Step 123). However, the present invention is not limited to the RANSAC, and the steps of the RANSAC are described as follows:

a. defining a set of block motion vectors S={dᵢ},iε=1 . . . m;

b. randomly selecting n block motion vectors, for calculating parameters of the affine module;

c. using the parameters obtained in Step b to predict the values of the other (m-n) block motion vectors, and indicating the vectors and the corresponding original motion vectors respectively as ρⱼ, dⱼ, jε1 . . . m−n;

d. calculating the residual error rⱼ between each predicted block motion vector pⱼ and the original block motion vector dⱼ, which is indicated by 2-norm distance there-between;

e. determining whether the value of each residual error rⱼ is smaller than a certain threshold value, and if yes, considering it as an inlier;

f. repeating the Steps b, c, d, and e for several times, outputting the affine module parameter that generates the most number of inliers in the several times of calculations, to act as the determination result of the global motion relation.

After the global motion relation between the target image and the reference image is determined (Step 123), in the present invention, the translation distance information in the global motion situation of the target image is used as the basis for generating the blur parameter. In the present invention, the horizontal translation and the vertical translation of the translation distance are used to generate the global motion vector, in which the blur parameter, called the blur direction (motion blur direction), is generated through the direction of the global motion vector; and the blur parameter, called the blur extent (motion blur extent), is generated through the length of the global motion vector (Step 124).

The steps of generating the restored image are further illustrated below (Step 130). In this embodiment, for example, a Wiener filter operating in the frequency domain is used to restore the image, but the present invention is not limited to the Wiener filter. In the present invention, the blur parameters, i.e., the blur angle and the blur extent in this embodiment, generated in Step 120 are used to establish a corresponding point spread function (PSF), and a Fourier transform function D(u, v) corresponding to the PSF.

Next, the present invention establishes the Wiener filter through the following process:

$$H ( u , v ) = \frac{{D}^{*} ( u , v )}{{D}^{*} ( u , v ) D ( u , v ) + \frac{{S}_{w} ( u , v )}{{S}_{f} ( u , v )}} .$$

After the Wiener filter has been established, in the present invention, the Fourier transform is performed on the target image, and the transformed target image is multiplied by the Wiener filter at each point coordinates of the frequency domain. Then, an inverse Fourier transform is performed on the result obtained through the mutual effect to obtain the restored image.

Practically, in order to make the restored image generated by the present invention have more desirable effect, after the restored image is generated (Step 130), the method of the present invention further includes a step of adjusting the blur parameter, so as to generate the restored image with more desirable image quality. After the image feature of the restored image has been extracted through the image feature extraction method (Step 140), the image feature of the restored image is used to calculate the image quality value of the restored image (Step 150). Then, the calculated image quality value is determined (Step 160), and specifically, if the image quality value of the restored image reaches the predetermined threshold value or becomes stable, the generated restored image has a certain image quality; otherwise, the blur parameter is automatically adjusted in the present invention (Step 170), and Steps 130 to 160 are repeated, so as to enhance the image quality of the generated restored image.

The process of extracting the image feature of the restored image is further illustrated below (Step 140). In this embodiment, the present invention uses three kinds of image feature extraction methods. The first one is to observe the changes of the contrast and the smoothness between the restored image and the target image, thereby extracting the image feature. As for the second and third image feature extraction methods, the image feature relevant to the blurring degree is respectively extracted from the spatial domain and the frequency domain of the restored image. The three kinds of image feature extraction methods are further illustrated below.

The first kind of image feature extraction method uses the changes of the contrast and the smoothness between the restored image I_restored and the target image I_blurred to calculate two image features, namely, a contrast enhancement ratio and a total variation (TV) improvement ratio. The process of calculating the contrast enhancement ratio is that

$$Contrast enhancement ratio = \frac{{\sum }_{x} {\sum }_{y} \frac{\vert I\_restored ( x , y ) - \overline{I\_restored ( x , y )} \vert}{\vert I\_blurred ( x , y ) - \overline{I\_blurred ( x , y )} \vert}}{total number of image pixels}$$

in which
I̅(̅x̅,̅y̅)̅ represents an average value of all the pixel strengths of the local block with the coordinates (x,y) as the center in the image I. The TV improvement ration is that

$$TV improvment ratio = \frac{TV ( I\_restored )}{TV ( I\_blurred )} ,$$

in which

$$TV ( I ) = {\sum }_{x} {\sum }_{y} \sqrt{{I}_{x}^{2} + {I}_{y}^{2}} .$$

In the second image feature extraction method, after an edge detection is performed on the restored image I_restored, each specific edge point (xi,yi) (i=1-N, N is the number of the specific edge points) is generated. Next, along the gradient direction of each edge point, the positions of the pixel with the partially maximum strength and the pixel with the partially minimum strength in the restored image are searched, which are respectively a first pixel (x1, y1) and a second pixel (x2, y2). The edge width w(xi, yi) corresponding to the edge point (xi, yi) is the distance between the first pixel and the second pixel, that is, d=√(x₁−x₂)²+(yᵢ−y₂)². After the edge widths of all the edge points have been calculated, the present invention makes statistics on all the edge widths w(xi, yi) in the restored image to obtain an edge width histogram. Then, the quantization is performed on the edge width histogram. Finally, the probability distributions corresponding to different edge widths are used as the image feature of the restored image.

In the third image feature extraction method, a two-dimensional Fourier transformation is performed on the restored image to obtain a Fourier image F(u, v). Next, the frequency spectrum of each transformed point coordinates (u, v) is calculated as |F(u,v)|², so as to obtain a frequency spectrum distribution diagram of the restored image. From the frequency spectrum distribution diagram, the frequencies of the two dimensions are respectively quantized, so as to combine several kinds of signal strengths at different frequencies as the image features of the restored image.

In the step of extracting the image feature (Step 140), it further includes performing a normalization process before obtaining the image feature. For example, the image feature obtained through the first image feature extraction method in this embodiment has the concept of relative ratio, and thus, the relative changing degree between the restored image and the target image can be used to reduce the effect of the image content on the image feature, so as to achieve the normalization objective. In the second image feature extraction method, after the edge width corresponding to each edge point in the restored image has been calculated, the average value of all the edge widths is not taken as the image feature, but it makes statistics on each edge width, and the probability distribution situation corresponding to each edge width is used as the image feature to achieve the normalization objective. Similar to the second image feature extraction method, the third image feature extraction method achieves the normalization objective by means of making statistics.

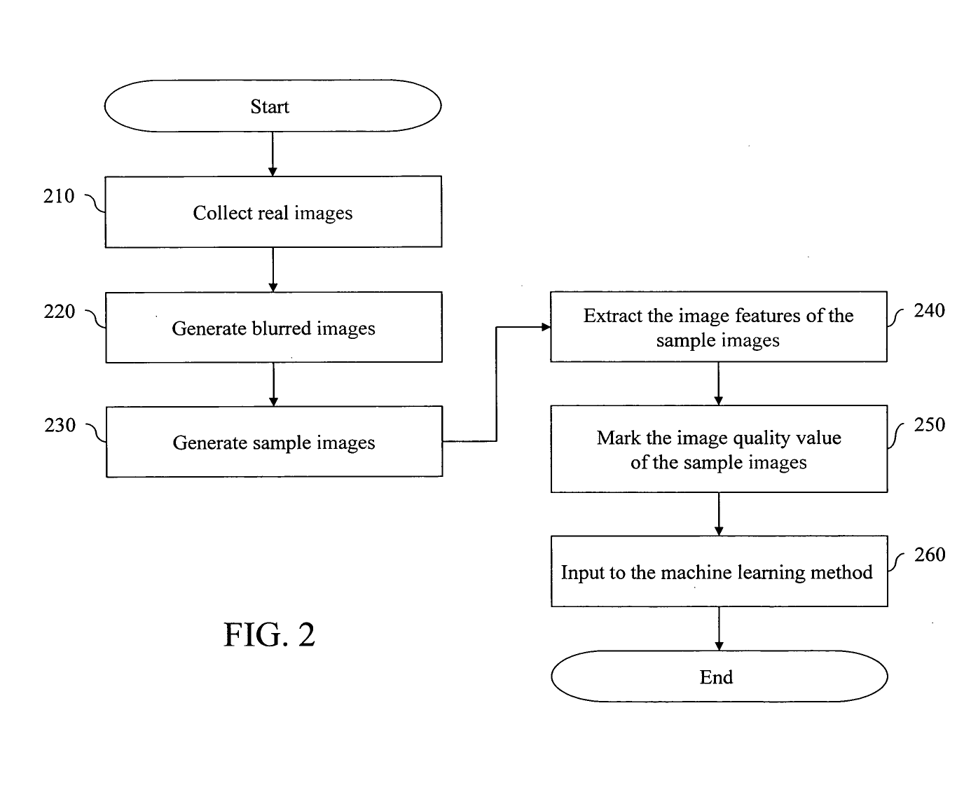

The calculation of the image quality value of the restored image is further illustrated below (Step 150), with reference to FIG. 2. In this embodiment, the image quality value is calculated through the pre-trained image quality assessment module, in which the process of pre-training the image quality assessment module is described as follows: firstly, collecting representative real images with desired focusing (Step 210); next, randomly generating various different simulative blur parameters (i.e., different blur angles and different blur extents in this embodiment), and generating the blurred images through each simulative blur parameter (Step 220), in which the simulative blur parameter corresponding to each blurred image is called the correct simulative blur parameter of each blurred image. In addition, the present invention is not limited to generating each simulative blur parameter randomly.

Before the blurred image is generated, the simulative blur parameter corresponding to the generated blurred image has already been obtained, such that blur parameters being different from the correct simulative blur parameter generated in Step 220 are set as the false blur parameters, and a parameter set formed by the set false simulative blur parameters and the correct simulative blur parameters is used to perform the image restoration on the blurred images. In this manner, after the image restoration, a set of sample images corresponding to the correct and false simulative blur parameters is obtained (Step 230). Next, in the present invention, the image feature of the sample images is extracted through the image feature extraction method (Step 240), and the image quality value of each sample image is marked (Step 250). The sample images corresponding to the correct simulative blur parameters are taken as the reference images, and their image quality values are marked as the highest values; and the sample images corresponding to the false simulative blur parameters are taken as the false restored images. Furthermore, as mentioned in the thesis, entitled by “Image quality assessment: From error visibility to structural similarity”, (IEEE Transactions on Image Processing, vol. 13, no. 4, pp. 600-612) proposed by Z. Wang, A. C. Bovik, H. R. Sheikh and E. P. Simoncelli in April, 2004, the structural similarity index (SSIM) between each false restored image and the reference image is used to mark the image quality value of each false restored image.

After the image feature of the sample images is extracted (Step 240) and the image quality value of each sample image is marked (Step 250), the image feature of each sample image and the corresponding image quality value are input into the machine learning method in the present invention (Step 260), such that the machine learning technique learns to suitably judge the image quality from the image feature of the restored image in the sample image, and generates an image quality assessment module used to calculate the quality value of the restored image. Thus, the pre-trained image quality assessment module is successively finished. In this embodiment, a RBF neural network is taken as an example of the machine learning method, but the present invention is not limited to this. In the present invention, after the image feature of the restored image is input into the RBF neural network, the RBF neural network outputs the image quality value of the restored image, such that the present invention obtains the image quality value of the restored image.

In addition, in the step of adjusting the blur parameter (Step 170), in order to prevent the circumstance that aimless adjusting of the blur parameter makes the image restored by using the adjusted blur parameter become meaningless, the present invention uses a numerical optimization method to adjust the blur parameter. The numerical optimization method of the present invention includes a downhill simplex search, a Levenberg-Marquardt (LM) algorithm, and the like. In this embodiment, the downhill simplex search is taken as an example. In this embodiment, since the blur parameters are a blur angle and a blur extent, the present invention defines a two-dimensional variable space (the blur angle is θ and the blur extent is Δ), and the specific point coordinates (θ,Δ) are searched in the variable space. The blur angle and the blur extent represented by the searched point coordinates (θ,Δ) are the blur parameters of this embodiment.

In addition, in order to prevent the time spent on adjusting the blur parameter to generate the restored image of the present invention from being excessively long, the present invention further includes a step of suitably defining a stop criterion, such that the present invention can obtain the restored image with the highest image quality value step by step within a limited time period. In this manner, the present invention can solve the problem that the error occurs when estimating the blur parameter.

Furthermore, the motion blurred image restoring method of the present invention can be realized in the hardware, the software, or combination of hardware and software, and can also be realized in one computer system through an integrated way, or realized in a scattered way through different elements scattered in several interconnected computer systems.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A motion blurred image restoring method, comprising:
reading a target image and a reference image neighboring to the target image of the motion blurring;
comparing the target image with the reference image to obtain a global motion relation between the target image and the reference image, and generating at least one blur parameter through the global motion relation; and
restoring the target image through the blur parameter to generate a restored image.

2. The motion blurred image restoring method as claimed in claim 1, wherein the global motion relation is generated after comparing the reference image with the target image by using a robust estimation process.

3. The motion blurred image restoring method as claimed in claim 1, wherein the global motion relation comprises a translation distance, a rotation angle, and a scaling between the reference image and the target image.

4. The motion blurred image restoring method as claimed in claim 1, wherein the step of generating the blur parameter comprises:
generating at least one block motion vector of the target image through the reference image;
calculating each block motion vector through a robust estimation process to generate a global motion relation, and generating a global motion vector for describing the global motion relation; and
defining the blur parameter with the global motion vector.

5. The motion blurred image restoring method as claimed in claim 4, wherein the step of generating at least one block motion vector includes comparing the reference image and the target image through a motion estimation process.

6. The motion blurred image restoring method as claimed in claim 4, wherein the step of generating at least one block motion vector comprises:
performing an eigen-decomposition on a structure tensor corresponding to the block motion vector to generate eigenvalues; and
eliminating the block motion vector corresponding to the eigenvalues, if it is determined that the block corresponding to the eigenvalues has a homogeneous or one-dimension structure.

7. The motion blurred image restoring method as claimed in claim 4, wherein the step of generating the global motion vector further comprises:
selecting a plurality of block motion vectors, for calculating a parameter of an affine module;
predicting the other block motion vectors through the parameter of the affine module;
calculating a residual error between the predicted block motion vectors and the corresponding original block motion vectors, and determining whether the original block motion vectors are inliers or not according to the residual error;
determining the global motion relation through the affine module parameter that generates the most batches of the inliers; and
generating a motion vector for describing the global motion through a translation distance of the global motion relation, including a horizontal translation and a vertical translation.

8. The motion blurred image restoring method as claimed in claim 4, wherein the blur parameter comprises a blur angle, and the blur angle is the direction of the global motion vector.

9. The motion blurred image restoring method as claimed in claim 4, wherein the blur parameter comprises a blur extent, and the blur extent is the length of the global motion vector.

10. The motion blurred image restoring method as claimed in claim 1, wherein the step of generating the blur parameter comprises:
extracting at least one image feature of the restored image through at least one image feature extraction method;
calculating an image quality value of the restored image through the image feature; and
adjusting the blur parameter, if the image quality value does not reach a preset threshold or is not stable.

11. The motion blurred image restoring method as claimed in claim 10, wherein the image feature extraction method comprises:
determining a change of a contrast and a smoothness between the restored image and the target image; and
calculating and generating the image feature according to the change of the contrast and the smoothness.

12. The motion blurred image restoring method as claimed in claim 10, wherein the image feature extraction method comprises:
performing an edge detection on the restored image to define at least one edge point;
searching a first pixel with partially maximum strength and a second pixel with partially minimum strength along a gradient direction of the edge point;
defining a distance between the first pixel and the second pixel as an edge width corresponding to the edge point; and
generating the image feature from a probability distribution of the edge width.

13. The motion blurred image restoring method as claimed in claim 10, wherein the image feature extraction method comprises:
transforming the restored image to a Fourier image;
calculating a frequency spectrum of coordinates for each point in the Fourier image, thereby obtaining a frequency spectrum distribution diagram; and
generating the image feature through each signal strength at different frequencies in the frequency spectrum distribution diagram.

14. The motion blurred image restoring method as claimed in claim 10, wherein the step of extracting the image feature further comprises a step of integrating the image feature through a normalization process.

15. The motion blurred image restoring method as claimed in claim 10, wherein the step of calculating an image quality value of the restored image is to calculate the image quality value with a pre-trained image quality assessment module.

16. The motion blurred image restoring method as claimed in claim 15, wherein the process of establishing the pre-trained image quality assessment module comprises:
collecting representative real images with desired focusing;
defining simulative blur parameters, and blurring the real images with the simulative blur parameters, thereby generating blurred images corresponding to the simulative blur parameters;
restoring the blurred images with a blur parameter set formed by correct simulative blur parameters and at least one false simulative blue parameter, thereby generating a plurality of sample images corresponding to the blur parameter set, wherein the sample images generated by restoring the blurred image with the correct simulative blur parameter are reference images that are marked with the highest sample image quality value; and the sample images generated by restoring the blurred image with the false simulative blur parameters are false restored images;
extracting the sample image feature of each sample image through the image feature extraction method;
calculating the sample image quality value of the false restored image through a similarity between the false restored image and the reference image; and
inputting the sample image feature and the sample image quality value to a machine learning method, such that the machine learning method learns to suitably judge the image quality value of the restored image from the image feature of the restored image.

17. The motion blurred image restoring method as claimed in claim 16, wherein the machine learning method is a neural network.

18. The motion blurred image restoring method as claimed in claim 10, wherein the step of adjusting the blur parameter comprises adjusting the blur parameter through using a numerical optimization process.

19. The motion blurred image restoring method as claimed in claim 10, further comprising defining a stop criterion, wherein if the restored image satisfies the stop criterion, the restored image is output.
